(19) United States
(12) Patent Application Publication
(10) Pub. No.: US 2010/0326781 A1
(43) Pub. Date: Dec. 30, 2010

(54) PISTON VALVE ASSEMBLY OF SHOCK ABSORBER

(76) Inventor: Hong Sig KIM, Jeollabuk-do (KR)

Correspondence Address: MCDERMOTT WILL & EMERY LLP, 600 13TH STREET, N.W., WASHINGTON, DC, 20005-3096, US

(21) Appl. No.: 12/821,557

(22) Filed: Jun. 23, 2010

(30) Foreign Application Priority Data
Jun. 30, 2009 (KR) 10-2009-0058756

(51) Int. Cl. F16F 9/34; F16F 9/18; F16K 1/00

(52) U.S. Cl. 188/322.15; 188/317; 251/324

(57) ABSTRACT

Disclosed is a piston valve assembly of a shock absorber. The shock absorber includes an inner cylinder completely filled with an operating fluid, an outer cylinder disposed outside the inner cylinder and partially filled with the fluid, and a piston rod. The piston valve assembly is provided to a lower end of the piston rod to divide the inner cylinder into rebound and compression chambers. The piston valve assembly includes a compression valve body having a compression fluid passage, a rebound valve body having a rebound fluid passage, an upper disc valve on the compression valve body, a lower disc valve below the rebound valve body, and a sliding piston sealingly adjoining the inner cylinder and having a penetration fluid passage. The sliding piston is slidably disposed between the compression and rebound valve bodies to slide while opening or closing a space between outer surfaces of the compression and rebound valves.

### BACKGROUND

1. Technical Field

The present disclosure relates to a shock absorber for damping vibration transmitted to a vehicle according to a road state and, more particularly, to a piston valve assembly of a shock absorber configured to enhance both driving comfort and handling performance of a vehicle.

2. Description of the Related Art

In general, a suspension system of a vehicle undergoes impact or vibration due to a shape or unevenness of a road during traveling on the road, and a passenger can suffer discomfort if the impact or vibration is directly transmitted to the passenger in the vehicle. The suspension system is provided with shock absorbers to relieve such impact or vibration and to enhance driving comfort by generating a buffering force.

Typically, the shock absorber includes an inner cylinder completely filled with an operating fluid, an outer cylinder disposed outside the inner cylinder and partially filled with the operating fluid, and a piston rod having one end disposed inside the inner cylinder and the other end extending outside the outer cylinder.

The piston rod is provided at a lower end thereof with a piston valve assembly that divides the interior of the inner cylinder into a rebound chamber and a compression chamber.

A body valve assembly is provided to a portion connecting lower ends of the inner and outer cylinders to each other, and is provided at a lower side thereof with a base cap that is press-fitted into the body valve assembly.

In a conventional shock absorber, enhancement of driving comfort causes deterioration in handling stability of the vehicle. Namely, the conventional shock absorber cannot satisfy both driving comfort and handling stability at the same time.

### BRIEF SUMMARY

The present disclosure is directed to solving the problems of the related art, and one embodiment includes a piston valve assembly of a shock absorber configured to enhance both driving comfort and handling performance of a vehicle without using an electronic control method.

In accordance with one aspect, there is provided a piston valve assembly of a shock absorber that includes an inner cylinder completely filled with an operating fluid; an outer cylinder disposed outside the inner cylinder and partially filled with the operating fluid; and a piston rod having one end disposed inside the inner cylinder and the other end extending outside the outer cylinder. The piston valve assembly is provided to a lower end of the piston rod to divide an interior of the inner cylinder into a rebound chamber and a compression chamber, and includes: a compression valve body having a compression fluid passage formed therein; a rebound valve body having a rebound fluid passage formed therein; an upper disc valve disposed on the compression valve body; a lower disc valve disposed under the rebound valve body; and a sliding piston having an outer surface sealingly adjoining an inner surface of the inner cylinder and having a penetration fluid passage formed therein. The sliding piston is disposed between the compression valve body and the rebound valve body to slide while opening or closing spaces between the sliding piston and an outer surface of the compression valve body and between the sliding piston and an outer surface of the rebound valve body.

The piston valve assembly may further include a separation guide having a hollow body disposed on an outer periphery of the piston rod between the compression valve body and the rebound valve body to provide a space between the compression valve body and the rebound valve body, wherein the sliding piston is slidably disposed on an outer periphery of the separation guide.

The sliding piston may include an upper opening/closing portion that opens or closes the space between the sliding piston and the outer surface of the compression valve body, and a lower opening/closing portion that opens or closes the space between the sliding piston and the outer surface of the rebound valve body.

The upper disc valve may be a multi-plate disc and a lowermost disc of the multi-plate disc may have a slit formed at a portion of an outer periphery thereof. The lower disc valve may be a multi-plate disc and an uppermost disc of the multi-plate disc may have a slit formed at a portion of an outer periphery thereof.

In accordance with one aspect, there is provided a piston valve assembly being provided around a piston rod of a shock absorber. The piston valve assembly comprises an upper valve body having an upper fluid passage formed therein, the upper fluid passage being selectively closed or opened by an upper valve thereon; a lower valve body having a lower fluid passage formed therein, the lower fluid passage being selectively closed or opened by a lower valve thereon; and a sliding piston having an penetration fluid passage formed therein, the sliding piston being disposed slidably between the upper valve body and the lower valve body so as to selectively connect the penetration fluid passage to the upper fluid passage or lower fluid passage. The piston valve assembly further comprises a separation guide having a hollow body disposed on an outer periphery of the piston rod between the upper valve body and the lower valve body to provide a space between the upper valve body and the lower valve body, wherein the sliding piston is slidably disposed on an outer periphery of the separation guide. The sliding piston comprises an upper opening/closing portion that opens or closes the space between the sliding piston and the outer surface of the upper valve body, and a lower opening/closing portion that opens or closes the space between the sliding piston and the outer surface of the lower valve body. The upper valve comprises a multi-plate disc and a lowermost disc of the multi-plate disc has a slit formed at a portion of an outer periphery thereof. The lower valve comprises a multi-plate disc and an uppermost disc of the multi-plate disc may have a slit formed at a portion of an outer periphery thereof.

### BRIEF DESCRIPTION OF THE DRAWINGS

FIG. 1 is a sectional view of a shock absorber including a piston valve assembly in accordance with an embodiment of the present disclosure;

FIG. 2 is a detailed sectional view of the piston valve assembly in accordance with the embodiment of the present disclosure; and

FIGS. 3 and 4 illustrate operation of the piston valve assembly in accordance with the embodiment of the present disclosure.

### DETAILED DESCRIPTION

Exemplary embodiments of the present disclosure will be described in detail with reference to the accompanying drawings.

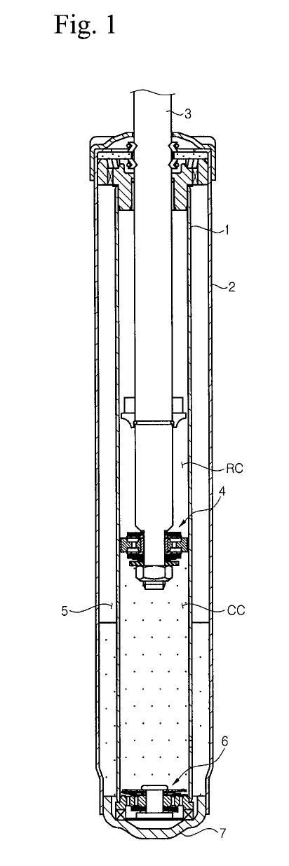

FIG. 1 is a sectional view of a shock absorber including a piston valve assembly in accordance with an embodiment of the present disclosure.

Referring to FIG. 1, a shock absorber 100 includes an inner cylinder 1 completely filled with an operating fluid, an outer cylinder 2 disposed outside the inner cylinder 1 and partially filled with the operating fluid, and a piston rod 3 having one end disposed inside the inner cylinder 1 and the other end extending outside the outer cylinder 2.

A piston valve assembly 4 is provided to a lower end of the piston rod 3 to linearly reciprocate inside the inner cylinder 1. Here, the piston valve assembly 4 divides the interior of the inner cylinder 1 into a rebound chamber RC and a compression chamber CC.

The inner cylinder 1 has a hollow body and is disposed inside the outer tube 2 to be separated a predetermined distance from an inner surface of the outer tube 2 so that an accommodation room 5 to be filled with an operating fluid is defined between the inner cylinder 1 and the outer cylinder 2. A body valve assembly 6 is provided to a portion connecting lower ends of the inner and outer cylinders 1, 2 to each other, and is provided at a lower side thereof with a base cap 7 that is press-fitted into the body valve assembly 6.

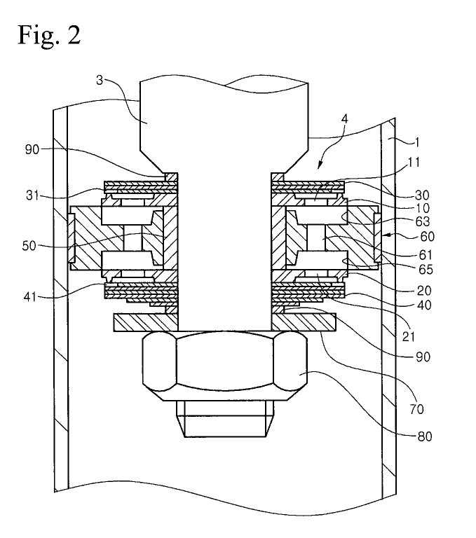

FIG. 2 is a detailed sectional view of the piston valve assembly in accordance with the embodiment of the present disclosure. Referring to FIG. 2, the piston valve assembly 4 includes a compression valve body(or an upper valve body) 10, a rebound valve body (or a lower valve body) 20, an upper disc valve 30, a lower disc valve 40, a separation guide 50, and a sliding piston 60.

The compression valve body 10 has a compression fluid passage (or an upper fluid passage) 11 therein, and the rebound valve body 20 has a rebound fluid passage (or lower fluid passage) 21 therein.

The compression valve body 10 and the rebound valve body 20 are separated from each other on the piston rod 3.

The upper disc valve 30 is disposed on the compression valve body 10, and the lower disc valve 40 is disposed under the rebound valve body 20.

The upper disc valve 30 is formed as a multi-plate disc, in which the lowermost disc of the multi-plate disc has a slit 31 formed at a portion of an outer periphery thereof.

The lower disc valve 40 is formed as a multi-plate disc, in which the uppermost disc of the multi-plate disc has a slit 41 formed at a portion of an outer periphery thereof.

The separation guide 50 is a hollow cylindrical body disposed on an outer periphery of the piston rod 3 between the compression valve body 10 and the rebound valve body 20 to provide a space between the compression valve body 10 and the rebound valve body 20.

The sliding piston valve 60 is slidably disposed on an outer periphery of the separation guide 50. The separation guide 50 allows smooth movement of the sliding piston 20 while providing a space which allows the sliding piston 60 to slide between the compression and rebound valve bodies 10, 20. The sliding piston 60 slides on the outer periphery of the separation guide 50 while opening or closing spaces between the sliding piston 60 and an outer surface of the compression valve body 60 and between the sliding piston 60 and an outer surface of the rebound valve body 20.

An outer surface of the sliding piston 60 sealingly adjoins the inner surface of the inner cylinder 1, and the sliding piston 60 is formed therein with a penetration flow passage 61, which permits fluid movement between the rebound chamber RC and the compression chamber CC.

The sliding piston 60 includes an upper opening/closing portion 63 opening or closing the space between the sliding piston 60 and the compression valve body 10, and a lower opening/closing portion 65 opening or closing the space between the sliding piston 60 and the rebound valve body 10.

Further, a lower washer 70 and a nut 80 are sequentially coupled to a lower side of the lower disc valve 40.

The upper disc valve 30 is secured to a step of the piston rod 3 with a retainer 90 interposed therebetween, and the lower disc valve 30 is also supported on the lower washer 70 with a retainer 90 interposed therebetween.

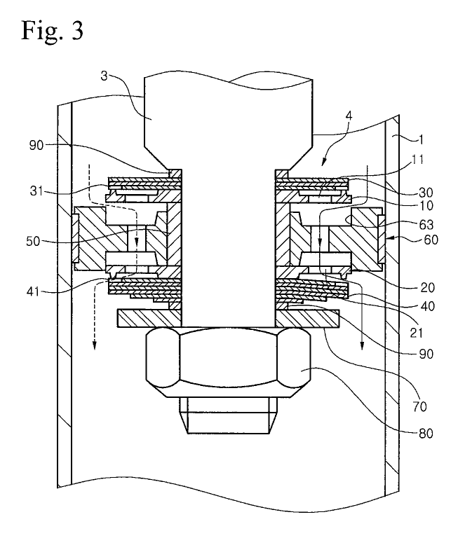

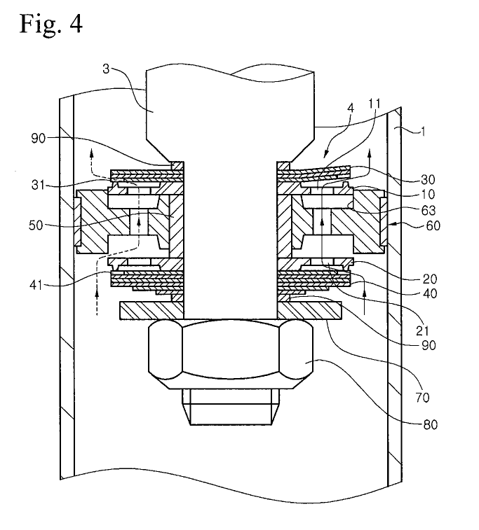

Next, operation of the piston valve assembly according to the embodiment will be described. FIGS. 3 and 4 illustrate operation of the piston valve assembly in accordance with the embodiment of the present disclosure.

When the shock absorber rebounds, an upper chamber in the piston valve assembly 4, that is, the rebound chamber RC, has a higher pressure than a lower chamber in the piston valve assembly 4, that is, the compression chamber CC, so that a pressure difference therebetween causes an operating fluid to flow from the upper chamber of the piston valve 4 to the lower chamber thereof. Here, the sliding piston 60 moves downward along the separation guide 50, so that the space between the outer surface of the compression valve body 10 and the upper opening/closing portion 63 of the sliding piston 60 is opened to allow the operating fluid to flow therein, and so that the space between the outer surface of the rebound valve body 10 and the lower opening/closing portion 65 of the piston valve 60 is closed to prevent the operating fluid from flowing therein. The operating fluid of the upper chamber of the piston valve assembly 4 introduced into the space between the outer surface of the compression valve body 10 and the upper opening/closing portion 63 of the sliding piston 60 flows in the rebound fluid passage 21 of the rebound valve body 20 through the penetration fluid passage 61 of the sliding piston 60. If a small amount of operating fluid is provided, the operating fluid flows into the lower chamber of the piston valve assembly 4 through the slit 41 of the lower disc valve 40, as indicated by a dotted line in a left half part of FIG. 3. If a large amount of operating fluid is provided, the operating fluid deforms the lower disc valve 40 and flows into the lower chamber of the piston valve assembly 4, as indicated in a right half part of FIG. 3.

When the shock absorber is compressed, the sliding piston 60 moves upward, so that the space between the outer surface of the rebound valve body 10 and the lower opening/closing portion 65 of the piston valve 60 is opened to allow the operating fluid to flow therein, and so that the space between the outer surface of the compression valve body 10 and the upper opening/closing portion 63 of the sliding piston 60 is closed to prevent the operating fluid from flowing therein. Then, generation and control of a buffering force are carried out as in the rebound cycle described above. An operating state of the shock absorber in the compression cycle is shown in FIG. 4.

Enhancement of driving comfort and handling performance of the vehicle may be simultaneously guaranteed by a movement distance of the sliding piston 60 and a combination of the compression valve body 10, upper disc valve 30 on the compression valve body, rebound disc valve 20, and lower disc valve 40 under the rebound valve body 20.

In other words, since the buffering force is reduced by the movement distance of the sliding piston 60, it is possible to guarantee good driving comfort of a passenger. Further, when the operating fluid passes through the respective fluid passages with the space between the sliding piston 60 and the compression valve body 10 closed or with the space between the sliding piston 60 and the rebound valve body 20 closed, the handling performance of the vehicle may be guaranteed by adjusting the diameters of the rebound fluid passage 21 of the rebound valve body 20 and the compression fluid passage 11 of the compression valve body 10, and elasticity of the upper and lower disc valves 30, 40.

Further, the buffering force at low speed, known to have a great influence on the driving comfort and handling performance of the vehicle, may be adjusted by adjusting cross-sectional areas of the slits 31, 41 of the upper and lower disc valves 30, 40.

As such, in the piston valve assembly of the shock absorber according to the embodiment, a sliding piston, which has an outer surface sealingly adjoining an inner surface of an inner cylinder and is formed with a penetration fluid passage, is disposed to slide between a compression valve body and an upper disc valve and between a rebound valve body and a lower disc valve while opening or closing spaces between the sliding piston and an outer surface of the compression valve body and between the sliding piston and an outer surface of the rebound valve body, so that both driving comfort and handling performance of a vehicle are simultaneously enhanced through a movement distance of the sliding piston and a combination of the compression valve body, upper disc valve, rebound valve body, and lower disc valve without using an electronic control method.

The various embodiments described above can be combined to provide further embodiments. All of the patents, patent application publications, patent applications, foreign patents, foreign patent applications and non-patent publications referred to in this specification are incorporated herein by reference, in their entirety. Aspects of the embodiments can be modified if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A piston valve assembly of a shock absorber including an inner cylinder completely filled with an operating fluid, an outer cylinder disposed outside the inner cylinder and partially filled with the operating fluid, and a piston rod having one end disposed inside the inner cylinder and the other end extending outside the outer cylinder, the piston valve assembly being provided to a lower end of the piston rod to divide an interior of the inner cylinder into a rebound chamber and a compression chamber, and including:
a compression valve body having a compression fluid passage formed therein;
a rebound valve body having a rebound fluid passage formed therein;
an upper disc valve disposed on the compression valve body;
a lower disc valve disposed on the rebound valve body; and
a sliding piston having an outer surface sealingly adjoining an inner surface of the inner cylinder and having a penetration fluid passage formed therein, the sliding piston being disposed between the compression valve body and the rebound valve body to slide while opening or closing spaces between the sliding piston and an outer surface of the compression valve body and between the sliding piston and an outer surface of the rebound valve body.

2. The piston valve assembly of claim 1, further comprising a separation guide having a hollow body disposed on an outer periphery of the piston rod between the compression valve body and the rebound valve body to provide a space between the compression valve body and the rebound valve body, wherein the sliding piston is slidably disposed on an outer periphery of the separation guide.

3. The piston valve assembly of claim 1, wherein the sliding piston comprises an upper opening/closing portion that opens or closes the space between the sliding piston and the outer surface of the compression valve body, and a lower opening/closing portion that opens or closes the space between the sliding piston and the outer surface of the rebound valve body.

4. The piston valve assembly of claim 3, wherein the upper disc valve is a multi-plate disc and a lowermost disc of the multi-plate disc has a slit formed at a portion of an outer periphery thereof, and
wherein the lower disc valve is a multi-plate disc and an uppermost disc of the multi-plate disc may have a slit formed at a portion of an outer periphery thereof.

5. A piston valve assembly being provided around a piston rod of a shock absorber, the piston valve assembly comprising:
an upper valve body having an upper fluid passage formed therein, the upper fluid passage being selectively closed or opened by an upper valve thereon;
a lower valve body having a lower fluid passage formed therein, the lower fluid passage being selectively closed or opened by a lower valve thereon; and
a sliding piston having an penetration fluid passage formed therein, the sliding piston being disposed slidably between the upper valve body and the lower valve body so as to selectively connect the penetration fluid passage to the upper fluid passage or lower fluid passage.

6. The piston valve assembly of claim 5, further comprising: a separation guide having a hollow body disposed on an outer periphery of the piston rod between the upper valve body and the lower valve body to provide a space between the upper valve body and the lower valve body, wherein the sliding piston is slidably disposed on an outer periphery of the separation guide.

7. The piston valve assembly of claim 5, wherein the sliding piston comprises an upper opening/closing portion that opens or closes the space between the sliding piston and the outer surface of the upper valve body, and a lower opening/closing portion that opens or closes the space between the sliding piston and the outer surface of the lower valve body.

8. The piston valve assembly of claim 5, wherein the upper valve comprises a multi-plate disc and a lowermost disc of the multi-plate disc has a slit formed at a portion of an outer periphery thereof, and wherein the lower valve comprises a multi-plate disc and an uppermost disc of the multi-plate disc may have a slit formed at a portion of an outer periphery thereof.
